(19) United States
(12) Patent Application Publication
(10) Pub. No.: US 2014/0023185 A1
(43) Pub. Date: Jan. 23, 2014

(54) Characterizing Time-Bounded Incident Management Systems

(71) Applicants: Ana Paula Appel, Vila Mariana (BR); Victor Fernandes Cavalcante, Campinas (BR); Rogerio Abreu De Paula, Terreo (BR); Claudio Santos Pinhanez, Sao Paulo (BR); Cleidson Ronald Botelho de Souza, Belem do Para (BR)

(72) Inventors: Ana Paula Appel, Vila Mariana (BR); Victor Fernandes Cavalcante, Campinas (BR); Rogerio Abreu De Paula, Terreo (BR); Claudio Santos Pinhanez, Sao Paulo (BR); Cleidson Ronald Botelho de Souza, Belem do Para (BR)

(73) Assignee: INTERNATIONAL BUSINESS MACHINES CORPORATION, Armonk, NY (US)

(21) Appl. No.: 13/557,285

(22) Filed: Jul. 25, 2012

Related U.S. Application Data
(63) Continuation of application No. 13/553,922, filed on Jul. 20, 2012.

(51) Int. Cl. H04M 3/523

(52) U.S. Cl. CPC H04M 3/5238
USPC 379/243

(57) ABSTRACT

A system and an article of manufacture for characterizing a time-bounded incident management system, which includes receiving a plurality of work requests into a time-bounded incident management system, each work request having a time-to-service requirement, determining an assignment delay and a resolution delay for each work request, and characterizing the time-bounded incident management system by classifying each work request into one of multiple classes according to assignment delay and resolution delay.

### CROSS-REFERENCE TO RELATED APPLICATIONS

This application is a continuation of U.S. patent application Ser. No. 13/553,922, filed Jul. 20, 2012, and incorporated by reference herein.

### FIELD OF THE INVENTION

Embodiments of the invention generally relate to information technology (IT), and, more particularly, to management of service systems.

### BACKGROUND

Systems to deliver and provision services are important engines of the new global economy where services are increasingly becoming a dominant mode of production. To meet those demands, more and more enterprises have established mass-scale, complex systems to deliver services using factory-like production methods, or service factories. The modern call center is a typical example of a service factory, but health, government, and IT services, among others, are being delivered through service factories.

Additionally, there has been a transformation in the ways in which computing and data processing are provided to organizations. The model marked by in-house data-centers was gradually replaced by a scenario in which many enterprises contract out the management of their IT infrastructure to other organizations. The delivery of IT services is often made through large IT service organizations whose operations involve innumerous support teams that oversee a network of thousands of servers, routers, and other IT equipment from multiple firms simultaneously.

It is common for service factories to have an organization devoted to handling incidents, or an incident management system. As used herein, an incident can be defined as any event which is not part of the standard operation of a service and which causes, or may cause, an interruption to or a reduction in the quality of that service. Incidents are, by definition, unpredictable and often demand rapid allocation of skilled resources for their resolution to return a service back to normal.

Many incident management systems have strict controls on how fast incidents should be handled, often subjected to penalties when targets are not met. Such systems are referred to herein as time-bounded incident management (TBIM) systems. Examples of TBIM systems can include, for example, fire and ambulance management, call centers with required maximum waiting and resolution times, and many IT service delivery operations.

Existing TBIM systems approaches deal largely with issues in queue management. However, such approaches merely focus on estimating the capacity of managing queue waiting-time.

### SUMMARY

In one aspect of the present invention, techniques for characterizing time-bounded incident management systems are provided, and include characterizing a time-bounded incident management system can include steps of receiving a plurality of work requests into a time-bounded incident management system, each work request having a time-to-service requirement, determining an assignment delay and a resolution delay for each work request, and characterizing the time-bounded incident management system by classifying each work request into one of multiple classes according to assignment delay and resolution delay.

This aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps. Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example ticket dispatching process, according to an embodiment of the present invention;

FIG. 2 is a diagram illustrating suggested meanings of ticket concentration in different areas of the work profile chart of a service pool, according to an embodiment of the present invention;

FIG. 3 is a flow diagram illustrating techniques for characterizing a time-bounded incident management system, according to an embodiment of the invention; and

FIG. 4 is a system diagram of an exemplary computer system on which at least one embodiment of the invention can be implemented.

### DETAILED DESCRIPTION

As described herein, an aspect of the present invention includes characterizing time-bounded incident management systems. At least one embodiment of the invention includes the use of an analytical tool, referred to herein as a work profile chart (WPC), to characterize the performance and quality of time-bounded incident management (TBIM) systems. Accordingly, aspects of the invention can include identifying classes of problems (also referred to herein as tickets or work requests) for automated resolution or assignment, determining resources and skills needed, and reaching a balance between productivity and quality.

As detailed herein, based on the normalization of ticket assignment and resolution by their respective service level agreement (SLA), at least one embodiment of the invention includes computing and plotting the spreading or the ticket assignment and resolution on a log-log chart. Specifically, ticket data of a service pool (SP) can be plotted on a two-dimensional log-log graphic where the axes correspond to the normalized assignment and resolution times. The resulting density map of this plot is the WPC of the service pool. This visual representation characterizes the performance of TBIM systems, helping to diagnose major issues such as resource and skill allocation, abnormal behavior, ticket characteristics, etc.

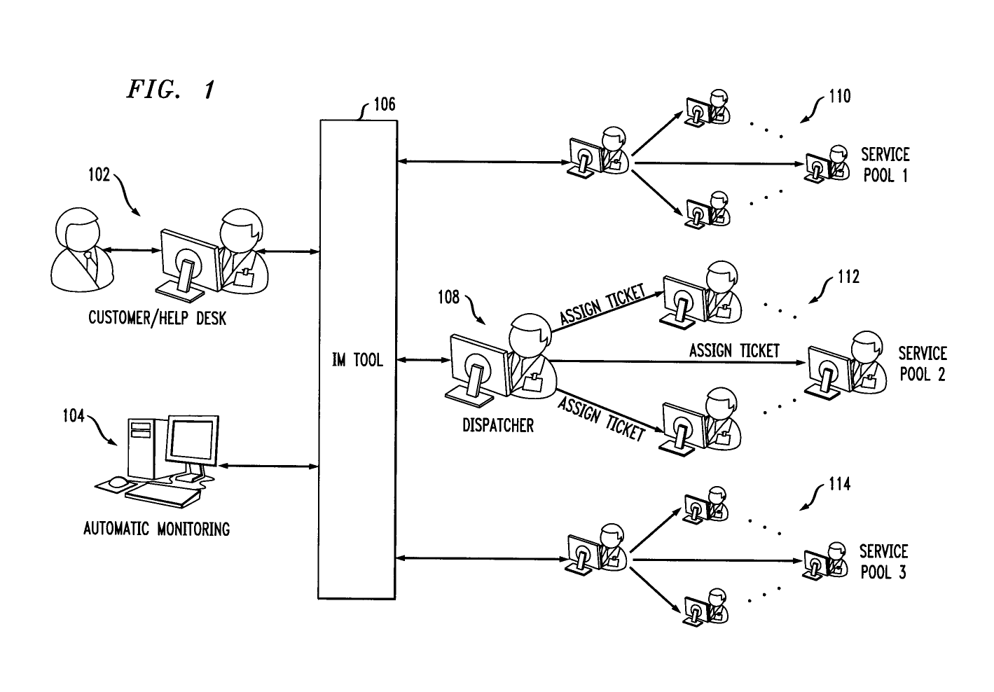

FIG. 1 is a diagram illustrating an example of a TBIM system, according to an embodiment of the present invention. By way of illustration, FIG. 1 depicts a customer or help desk 102, an automatic monitoring component 104, an incident management (IM) tool 106, a dispatcher 108, and service pools 110, 112 and 114.

Dispatching within a pooled model has as a primary function of managing the recurring, steady-state workload of tickets associated to the maintenance of the IT infrastructure of multiple clients in an optimized fashion. As part of this process, the dispatcher 108 is the person within the pool whose primary activity is to monitor all tickets coming from a particular group of customers 102 and to manage their assignment, progress, and completion, on time. Furthermore, due to the close relationship between customer perception about the service level being effectively delivered and SLA fulfillment, dispatching is likely to affect customer satisfaction.

Income workloads generated by tickets are handled by the service pools (such as 110, 112 and 114) with the support of IM systems. Tickets can be routed from these systems to a pool by placing the tickets into accessible queues, where the dispatcher 108 and the sys-admins can then monitor work to be done. FIG. 1 illustrates the dynamics of such ticket dispatching. Typically, tickets are created by customer 102 requests or fired by monitoring alerts (automated scripts 104) and routed to pools through incident management (IM) tools 106, which handle the ticket information. Based on the dispatching strategy adopted by the dispatcher 108 working in the service pool, every incoming ticket is forwarded from its input queue to a sys-admin in a service pool (such as 110, 112 and 114) skilled to solve the incident appropriately.

Accordingly, an aspect of the invention includes developing and validating a method to evaluate the performance of service pools in a TBIM system. As noted, at least one embodiment of the invention includes plotting the ticket data of a service pool on a two-dimensional log-log graphic where the axes correspond to the normalized assignment and resolution times. The density map of this plot is referred to as the workload profile chart (WPC) of the service pool. Further, at least one embodiment of the invention includes taking the WPC of a service pool and systematically examining the concentration levels on different areas. As additionally detailed herein, high or low concentration of tickets in a particular area corresponds to a set of specific characteristics likely to describe the reality of a service pool.

Analyzing the performance of service pools in terms of SLA attainment require the work within a service pool to be divided into two moments of a incoming ticket timeline: before and after the ticket assignment to a sys-admin. To construct the WPC, at least one embodiment of the invention includes normalizing the tickets' assignment delays and resolution times by their respective SLA duration, and plotting the information on a normalized assignment delay and resolution time space.

A logarithmic version of that space can be considered and a corresponding density matrix computed by dividing space into smaller bins (that is, a grid) and counting the number of tickets within each bin. Accordingly, in at least one embodiment of the invention, the WPC is the depiction of the log-log density matrix with a grey scale associated to different ranges of ticket concentration.

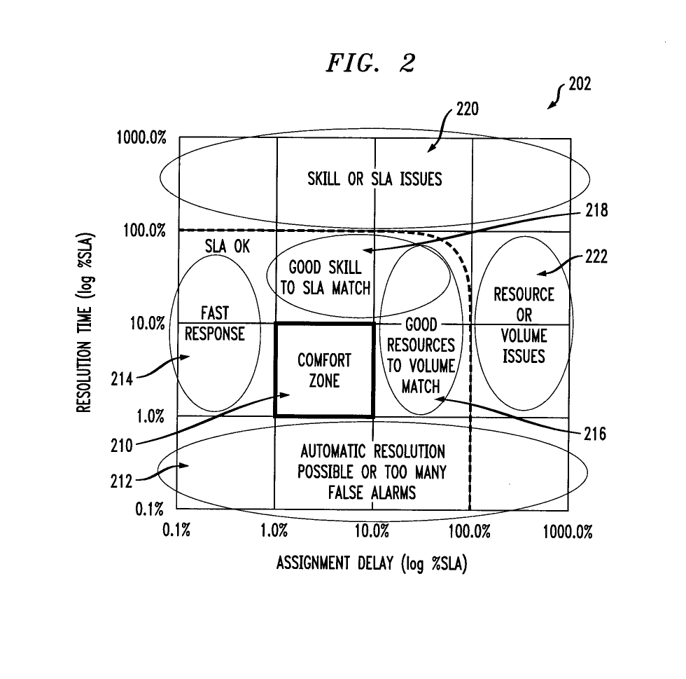

FIG. 2 is a grid 202 illustrating suggested meanings of ticket concentration in different areas of the WPC of a service pool, according to an embodiment of the present invention. By way of illustration, FIG. 2 depicts example insights that a WPC can provide. Specifically, consider the area in the WPC comprising between 0.1% and 1000% of both the log of the assignment delay (X axis) and the log of resolution time (Y axis). This area is conceptually divided into 16 squares of equal sizes, 9 of which roughly corresponding to the area in which tickets that meet SLA are plotted, as identified in FIG. 2 by the squares bounded within the dashed line.

As also illustrated in FIG. 2, the 16 squares are grouped into seven areas, each corresponding to specific issues, detailed as follows:
Comfort Zone 210: this area, found at the center of the example WPC of FIG. 2 [1%-10%, 1%-10%] contains tickets that are quickly assigned and resolved. A high concentration of tickets in the comfort zone 210 indicates that the TBIM system is working smoothly and comfortably, with most tickets easily finding resources to work on them and the corresponding issues being solved without much difficulty. In visual plots of WPC in example embodiments of the invention, a square is drawn over this area for reference (such as illustrated in FIG. 2).
Automatic Resolution/False Alarms 212: this area, covering tickets at the four bottom squares of the example WPC of FIG. 2, corresponds to tickets whose resolution takes less than 1.0% of the SLA [0.1%-1000%, 0.1%-1.0%]. Tickets here are either tasks whose resolution is so simple that the tickets are good candidates for automatic resolution methods, or tickets easily recognized as false alarms and therefore easily dismissible. A high concentration of tickets here suggests that the performance of the WPC can be greatly improved by better ticket automation or filtering approaches.
Fast Response 214: this area, covering the two top left squares of the SLA OK zone of the example WPC of FIG. 2 [0.1%-1%, 1.0%-100%] contains tickets that are quickly assigned (and possibly eased) but whose resolution may take some time. A high concentration here indicates not only that resources are rapidly made available for ticket resolution but also that the dispatching process is immediate, and therefore there is no need for lengthy diagnosis before assignment. Tickets in this area are good candidates for automatic dispatching.
Good Resources to Volume Match 216: this area covers the squares to the right of Comfort Zone 210 of the example WPC of FIG. 2 [10%-100%, 1%-100%], containing tickets to which assignment is not immediate and whose resolution takes some time. In addition, only tickets that meet their respective SLAs belong to this area. A high concentration of tickets here indicates that resources are not always immediately available, so assignment takes some time, but that does not compromise the SLA attainment. Systems with heavy concentration in this area have good levels of resource utilization.
Good Skill to SLA Match 218: this area corresponds to the squares situated on the top right of the comfort zone 210 of the example WPC of FIG. 2 [1%-100%, 10.0%-100%] and includes only tickets which meet their SLAs. Tickets in this area require a non-trivial amount of effort for their resolution and therefore adequate skill matching is often important. A high concentration of tickets here indicates that resolution tasks can be time-consuming and that the current time assigned to SLAs cannot be made tighter without adding more resources and/or more skilled resources to the system.
Skill or SLA Issues 220: this area covers tickets whose resolution required more than 100% of the SLA time. Tickets here are lost either because the resource assigned does not have the right skills to complete the task on time or the task requires a resolution time beyond SLA. A heavy concentration of tickets here usually indicates serious resource skills issues or a need to renegotiate SLAs.
Resource or Volume Issues 222: this area covers tickets that do not meet their SLA but whose resolution takes less than 100% of the SLA time. In other words, tickets in this area can be saved if they are assigned without much delay. A heavy concentration of tickets here often indicates that the service pool is not appropriately dimensioned or has dispatching problems.

Accordingly, at least one embodiment of the invention includes WPC inspection techniques to characterize a TBIM system or component. Such techniques, as further detailed herein, can include the following steps. The group of tickets corresponding to the TBIM system or component being analyzed can be selected for a certain period of time. The associated WPC can be computed. The concentrations of tickets in the WPC can be determined visually or through computational inspection of the WPC log-log density matrix. Additionally, for each of the main concentration areas of tickets, an aspect of the invention includes verifying to which of the seven areas described above each concentration area belongs and apply the characterization to the system or component accordingly.

As noted, WPC inspection can be based on the visual inspection of a WPC, using a tool to plot the charts for human observers, or implemented into an automatic system employing data searching and pattern recognition methods to detect the main concentration of tickets.

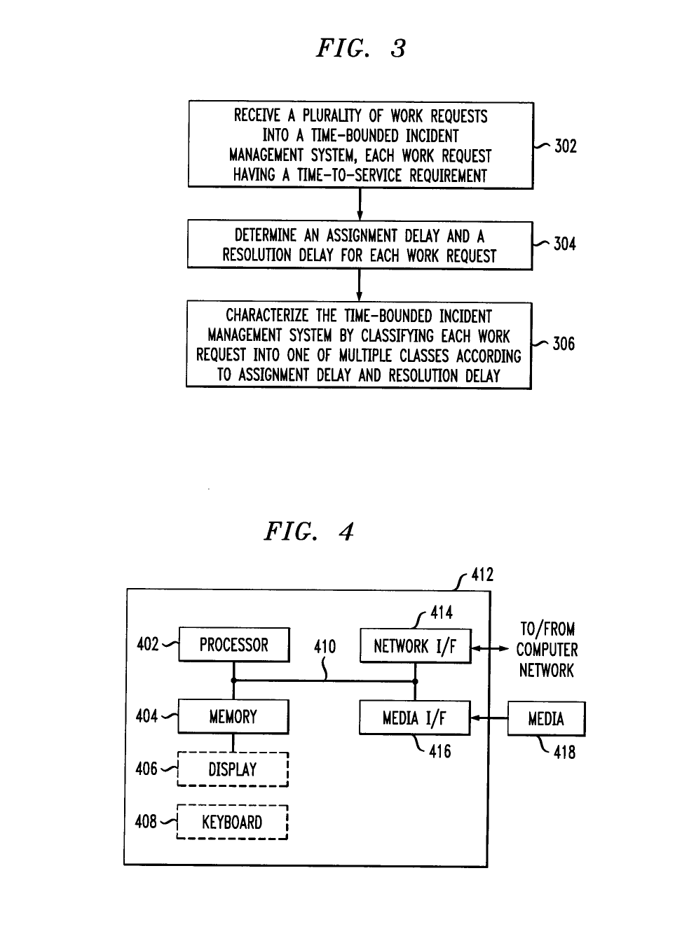

FIG. 3 is a flow diagram illustrating techniques for characterizing a time-bounded incident management system, according to an embodiment of the present invention. Step 302 includes receiving a plurality of work requests (also referred to herein as tickets) into a time-bounded incident management system, each work request having a time-to-service requirement. As detailed herein, the time-to-service requirement can be determined by a service level agreement. Step 304 includes determining an assignment delay and a resolution delay for each work request.

Step 306 includes characterizing the time-bounded incident management system by classifying each work request into one of multiple classes according to assignment delay and resolution delay. The classes identify characterizations and/or problems for automated resolution or assignment of a work request.

The classes can include a class indicating that a work request is efficiently assigned and resolved, a class indicating that a work request is a candidate for automatic resolution or is recognized as a false alarm and therefore dismissible, a class indicating that a work request is quickly assigned but slowly resolved, and a class indicating that a work request slowly assigned and slowly resolved. Additionally, the classes can include a class indicating that a work request requires a non-trivial amount of effort for resolution, a class indicating that a work request is lost either because a resource assigned does not have necessary skills to resolve the work request on time or the work request requires a resolution time beyond the time-to-service requirement, and a class indicating that a work request can be resolved within the time-to-service requirement only if assignment is made quickly.

As also detailed herein, characterizing the time-bounded incident management system by classifying each work request into one of multiple classes can include computing a work profile chart for each work request. Computing a work profile chart includes normalizing the assignment delay and the resolution delay for each work request by respective service level agreement time-to-service requirement duration. This can additionally include plotting the normalized assignment delay and the normalized resolution delay for each work request on a space.

The space can include a two-dimensional log-log graphic where the axes correspond to the normalized assignment and resolution delays. Also, one or more embodiments of the invention include considering logarithmic version of the space and computing a corresponding density matrix computed by dividing the space into multiple sub-sections. Further, at least one embodiment of the invention includes counting the number of work requests within each sub-section to determine concentrations of work requests in the work profile chart to characterizing the time-bounded incident management system. An embodiment of the invention can also include implementing an automatic system employing data searching and pattern recognition methods to detect concentration of work requests in the work profile chart.

As additionally described herein, at least one embodiment of the invention includes separately characterizing individual service pool components of the time-bounded incident management system.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 402. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, automatically representing and analyzing service performance and quality of time-bounded incident management.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An article of manufacture comprising a computer readable storage medium having computer readable instructions tangibly embodied thereon which, when implemented, cause a computer to carry out a plurality of method steps comprising:
receiving a plurality of work requests into a time-bounded incident management system, each work request having a time-to-service requirement;
determining an assignment delay and a resolution delay for each work request; and
characterizing the time-bounded incident management system by classifying each work request into one of multiple classes according to assignment delay and resolution delay.

2. The article of manufacture of claim 1, wherein the time-to-service requirement is determined by a service level agreement.

3. The article of manufacture of claim 1, wherein the classes identify characterizations and/or problems for automated resolution or assignment of a work request.

4. The article of manufacture of claim 3, wherein the classes include a class indicating that a work request is efficiently assigned and resolved.

5. The article of manufacture of claim 3, wherein the classes include a class indicating that a work request is a candidate for automatic resolution or is recognized as a false alarm and therefore dismissible.

6. The article of manufacture of claim 3, wherein the classes include a class indicating that a work request is quickly assigned but slowly resolved.

7. The article of manufacture of claim 3, wherein the classes include a class indicating that a work request slowly assigned and slowly resolved.

8. The article of manufacture of claim 3, wherein the classes include a class indicating that a work request requires a non-trivial amount of effort for resolution.

9. The article of manufacture of claim 3, wherein the classes include a class indicating that a work request is lost either because a resource assigned does not have necessary skills to resolve the work request on time or the work request requires a resolution time beyond the time-to-service requirement.

10. The article of manufacture of claim 3, wherein the classes include a class indicating that a work request can be resolved within the time-to-service requirement only if assignment is made quickly.

11. The article of manufacture of claim 1, wherein characterizing the time-bounded incident management system by classifying each work request into one of multiple classes comprises computing a work profile chart for each work request.

12. The article of manufacture of claim 11, wherein computing a work profile chart comprises normalizing the assignment delay and the resolution delay for each work request by respective service level agreement time-to-service requirement duration.

13. The article of manufacture of claim 12, wherein the method steps comprise plotting the normalized assignment delay and the normalized resolution delay for each work request on a space.

14. The article of manufacture of claim 13, wherein the space comprises a two-dimensional log-log graphic where the axes correspond to the normalized assignment and resolution delays.

15. The article of manufacture of claim 13, wherein the method steps comprise:
considering logarithmic version of the space; and
computing a corresponding density matrix computed by dividing the space into multiple sub-sections.

16. The article of manufacture of claim 15, wherein the method steps comprise counting the number of work requests within each sub-section to determine concentrations of work requests in the work profile chart to characterizing the time-bounded incident management system.

17. The article of manufacture of claim 15, wherein the method steps comprise implementing an automatic system employing data searching and pattern recognition methods to detect concentration of work requests in the work profile chart.

18. The article of manufacture of claim 1, wherein characterizing the time-bounded incident management system comprises separately characterizing individual service pool components of the time-bounded incident management system.

19. A system for characterizing a time-bounded incident management system, comprising:
at least one distinct software module, each distinct software module being embodied on a tangible computer-readable medium;
a memory; and
at least one processor coupled to the memory and operative for:
receiving a plurality of work requests into a time-bounded incident management system, each work request having a time-to-service requirement;
determining an assignment delay and a resolution delay for each work request; and
characterizing the time-bounded incident management system by classifying each work request into one of multiple classes according to assignment delay and resolution delay.
